(19) United States
(12) Patent Application Publication
(10) Pub. No.: US 2003/0002595 A1
(43) Pub. Date: Jan. 2, 2003

(54) Signal receiver of OFDM system and method for receiving signals thereof

(76) Inventors: Ki Seon Kim, Kwangju-si (KR); Hyun Jae Kim, Incheon-si (KR)

Correspondence Address: BIRCH STEWART KOLASCH & BIRCH, PO BOX 747, FALLS CHURCH, VA, 22040-0747, US

(21) Appl. No.: 09/882,027

(22) Filed: Jun. 18, 2001

(30) Foreign Application Priority Data
Apr. 16, 2001 (KR) 2001-20223

(51) Int. Cl. H04L 27/06

(52) U.S. Cl. 375/316; 375/376

(57) ABSTRACT

A signal receiver of an OFDM system and a method for receiving signals thereof are disclosed. Successive data are extracted/operated/stored from receiving signals of the OFDM system for each unit of symbol. Then, considering phase difference of successive symbols, error due to a random signal can be reduced and error signals that remove frequency offset of the receiving signals and synchronize the receiving signals are generated through an error detector of a PLL. When sufficient performance is not obtained due to the length of data of a protection period used in the OFDM system or frequency efficiency required for the OFDM system is relatively high, the OFDM system having an improved performance can be provided.

### BACKGROUND OF THE INVENTION

1. Field of the Invention

The present invention relates to a signal receiver of an orthogonal frequency division multiplexer (OFDM) system and a method for receiving signals thereof, and more particularly to a signal receiver of an OFDM system and a method for receiving signals thereof, which are available when sufficient performance is not obtained due to the length of a protection period used in receiving signals of the OFDM system or when required frequency efficiency is significantly high.

2. Description of the Related Art

Generally, an OFDM is one of frequency transmission modes and corresponds to a kind of a multicarrier modulation method in digital signal transmission. Particularly, the OFDM transmits data together with a plurality of sub carriers in parallel during a long symbol period constituting a transceiver signal in a frequency band used for carrier data transmission. Accordingly, the OFDM is effective to relax delay spreading effect of a signal under radio channel environments.

However, the OFDM is very susceptible to carrier frequency offset. In other words, if fine frequency error exists between a transmitter of the OFDM system and an oscillator of a receiver, orthogonality between sub channels is destroyed, thereby deteriorating the whole performance of the OFDM system.

Therefore, to maintain orthogonality between the channels, the OFDM system requires complete frequency synchronization. The step of removing frequency offset in the OFDM system includes an optical width estimating step and a fine estimating step. The optical width estimating step includes estimating substantial frequency offset corresponding to integer multiple of the distance between sub channels. The fine estimating step includes estimating residual frequency error.

In the receiver of the OFDM system, the frequency error is removed through a detection loop using a frequency error estimated value provided by a frequency error detector. Generally, the frequency error detector used for frequency synchronization is divided into a frequency error detector based on pilot and a frequency error detector based on a protection period.

The receiver of the OFDM system, as shown in FIG. 1, includes a phase-locked loop (PLL) 1 for synchronizing receiving signals, a serial to parallel (S/p) converter 2 for converting the synchronized signals to parallel signals, a Fourier transform unit 3 for fast Fourier transforming the converted signals, a QPSK unit 4 for modulating amplitude and phase of the Fourier transformed signals, and a parallel to serial (P/S) converter 5 for converting the modulated signals to serial signals. In such a receiver of the OFDM system, the frequency error detector based on pilot is used for frequency offset estimation of pilot data after the Fourier transform unit 3.

On the other hand, since the frequency error detector based on the protection period controls the frequency offset using data of the protection period without pilot data, it has an advantage that frequency efficiency is better and complexity is lower than the frequency error detector based on pilot. In more detail, the PLL 1 includes a multiplexer 1a for generating error signals using data of the protection period at the front end of the S/P converter 2, an analog to digital converter 1b, an error detector 1c, a digital to analog converter 1d, a loop filter le, and a voltage controlled oscillator (VCO) 1f. In a point of a position A, the frequency error detector based on the protection period removes the frequency error by multiplying the receiving signals input using the multiplexer la by e^{-j2πf}^{_{c}}^{t} generated through the PLL 1.

The equation of generating the error signals of the frequency error detector based on the existing protection period is as follows.

$$\begin{matrix}{e}_{1} ( l ) = \frac{1}{2 π T} ∠ \{ {\sum }_{l = 1}^{L} {γ}_{I , N - l γ} {γ}_{I , - l}^{*} \} . & ( 1 ) \\ {e}_{2} ( l ) = \frac{1}{L} {\sum }_{l = 1}^{L} I m ( {γ}_{I , N - l} {γ}_{I , - l}^{*} ) . & ( 2 )\end{matrix}$$

In the above equations (1) and (2), ∠(•)represents an angle of (•), Im (•)represents an imaginary value, and L represents the number of data of the protection period used to estimate the error signals e(l).

A related art guard interval based frequency error detector (GIB FED-I) based on the equation (1) generates the error signals using phase difference between available data away from the data of the protection data by n number of data. On the other hand, a related art GIB FED-II based on the equation (2) generates error signals using imaginary data between available data away from the data of the protection data by n number of data.

However, in a multipath channel, since the data of the protection period generate inter-symbol interference (ISI) signal that causes interference with a previous symbol, performance of the OFDM system depends on the length of the protection period. In other words, if the length of the protection period is not sufficient, or if required frequency efficiency is relatively high, a problem arises in that it is difficult to manufacture an OFDM system having a desired performance.

### SUMMARY OF THE INVENTION

It is, therefore, an object of the present invention to provide a signal receiver of an OFDM system and a method for receiving signals thereof, which excellent performance can be obtained using a multiple-guard interval based frequency error detector (M-GIB FED) that generates error signals from receiving signals of an OFDM system for each unit of symbol through data of a protection period.

To achieve the above object, there is provided a signal receiver of an OFDM system according to the present invention including a PLL for generating error signals using successive data among receiving signals of a symbol unit and synchronizing the receiving signals in accordance with the error signals, an S/P converter for converting the synchronized signals to parallel signals, a Fourier transform unit for fast Fourier transforming the converted parallel signals, a signal modulation unit for modulating amplitude and phase of the Fourier transformed signals, and a P/S converter for converting the modulated signals to serial signals.

To further achieve the above object, there is provided a method for receiving signals of an OFDM system according to the present invention including the steps of a) generating error signals using successive data among receiving signals of the OFDM system for each unit of symbol, b) removing offset of the receiving signals in accordance with the error signals and synchronizing the receiving signals, and c) modulating amplitude and phase of the synchronized receiving signals to process the modulated signals in the OFDM system.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram illustrating a signal receiver of an OFDM system according to the related art;

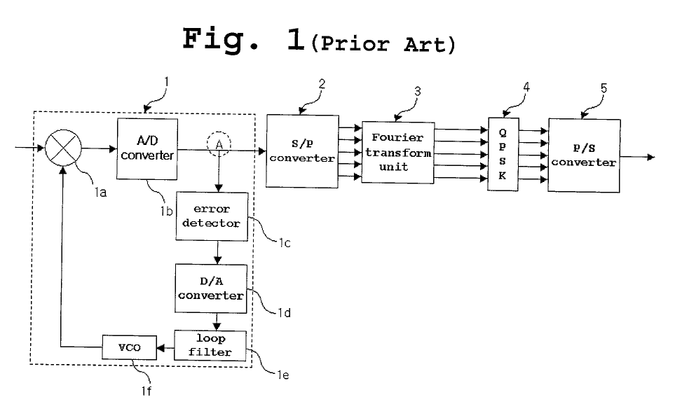

FIG. 2 is a block diagram illustrating a signal receiver of an OFDM system according to the present invention;

FIG. 3 is a flow chart illustrating a method for receiving signals of the OFDM system according to the present invention;

FIG. 4 is a block diagram illustrating a method of adding external receiving signals in accordance with the flow chart of FIG. 3;

FIG. 5 is an equivalent circuit diagram illustrating the signal receiver of the OFDM system of FIG. 2; and

FIGS. 6 and 7 are graphs illustrating simulation results of performance of the signal receiver of the OFDM system according to the present invention and performance of the signal receiver of the OFDM system according to the related art.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

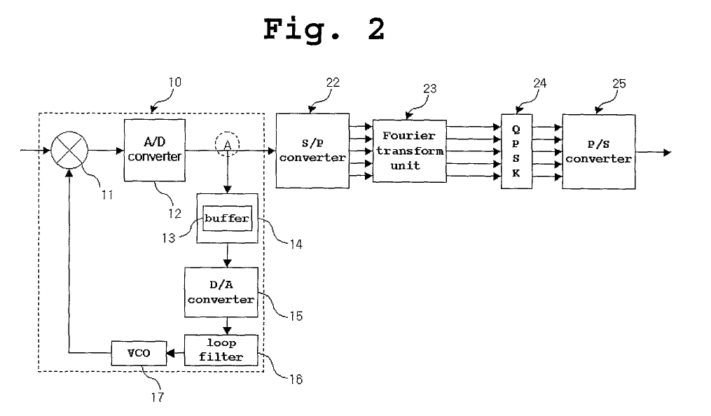

A signal receiver of an OFDM system according to the present invention, as shown in FIG. 2, includes a PLL 10, an S/P converter 22, a fast Fourier transform (FFT) unit 23, a signal modulation unit 24, and a P/S converter 25. The PLL 10 generates error signals through a buffer 13 that serves to store successive data among external receiving signals of an OFDM system for each unit of symbol, and removes offset of the receiving signals in accordance with the error signals and synchronizes the receiving signals. The S/P converter 22 converts the synchronized signals to parallel signals. The fast Fourier transform unit 23 Fourier transforms the converted parallel signals. The signal modulation unit 24 modulates amplitude and phase of the Fourier transformed signals in accordance with a QPST mode to process the Fourier transformed signals in the OFDM system. The P/S converter 25 converts the modulated signals to serial signals and outputs the converted serial signals to the OFDM system.

The PLL 10 includes a multiplexer 11, an A/D converter 12, an error detector 14, a D/A converter 15, a loop filter 16, and a VCO 17. The multiplexer 11 removes frequency offset of the external receiving signals in accordance with the generated error signals. The A/D converter 12 converts the signals, in which frequency offset is removed through the multiplexer 11, to digital signals and outputs the converted digital signals to the S/P converter 22. The error detector 14 adds the successive data of the receiving signals output through the A/D converter to generate the error signals in accordance with phase difference of the receiving signals. The D/A converter 15 converts the error signals generated by the error detector 14 to analog signals. The loop filter 16 converts the analog signals converted through the D/A converter 15 to direct current (DC). The VCO 17 synchronizes the error signals in accordance with the DC converted through the loop filter 16 to remove the frequency offset of the external receiving signals in the multiplexer 11 and at the same time synchronize the receiving signals.

Particularly, the error detector 14 includes at least one buffer 13 that stores a first resultant value obtained by adding data of the protection period corresponding to the I-1^{st} symbol among the receiving signals of symbol unit output through the A/D converter 12 to actual available data and at the same time stores a third resultant value obtained by adding the first resultant value to a second resultant value obtained by adding data of the protection period corresponding to the Ith symbol of the receiving signals to the second resultant value.

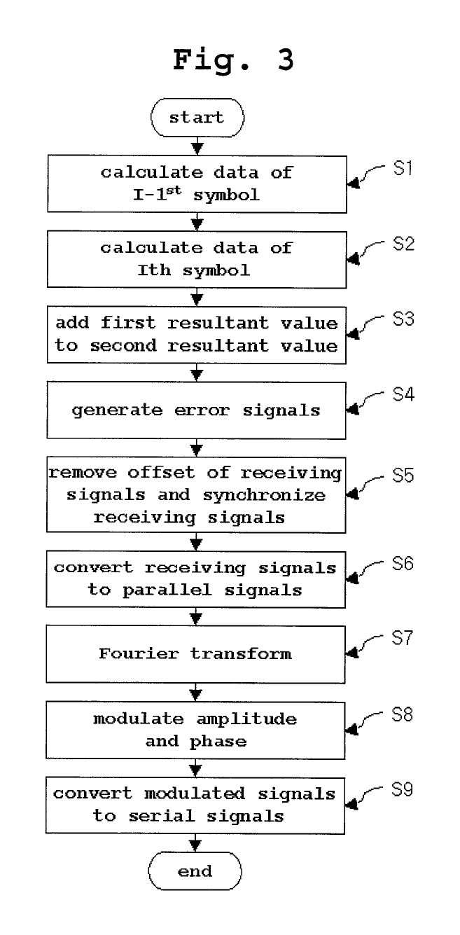

The operation of the signal receiver of the OFDM system according to the present invention will now be described with reference to FIG. 3.

First, in step S1, among external receiving signals of the OFDM system for each unit of symbol, L data of a protection period of the I-1^{st} symbol are respectively multiplied by and added to L actual available data by the error detector and a first resultant value is stored in the buffer.

In step S2, among the external receiving signals of the OFDM system for each unit of symbol, L data of a protection period of the Ith symbol are respectively multiplied by and added to L actual available data by the error detector and a second resultant value is generated.

In step S3, the error detector adds the second resultant value to the first resultant value stored in the buffer so that a third resultant value is generated.

In step S4, in accordance with the third resultant value in step S3, the error signals due to phase difference of two successive symbols among the external receiving signals are generated through the error detector, the loop filter, and the VOC.

In step S5, the frequency offset of the external receiving signals received in the multiplexer is removed in accordance with the error signals generated in step S4 and the external receiving signals are synchronized.

In step S6, the receiving signals passed through the PLL are converted to the parallel signals through the S/P converter.

In steps S7 and S8, the receiving signals converted to the parallel signals in step S6 are Fourier transformed through the Fourier transform unit and their amplitude and phase are modulated through the signal modulation unit so that they can be processed by the OFDM system.

In step S9, the external receiving signals transformed/modulated in steps S7 and S8 are converted to the serial signals through the P/S converter and then output to the OFDM system.

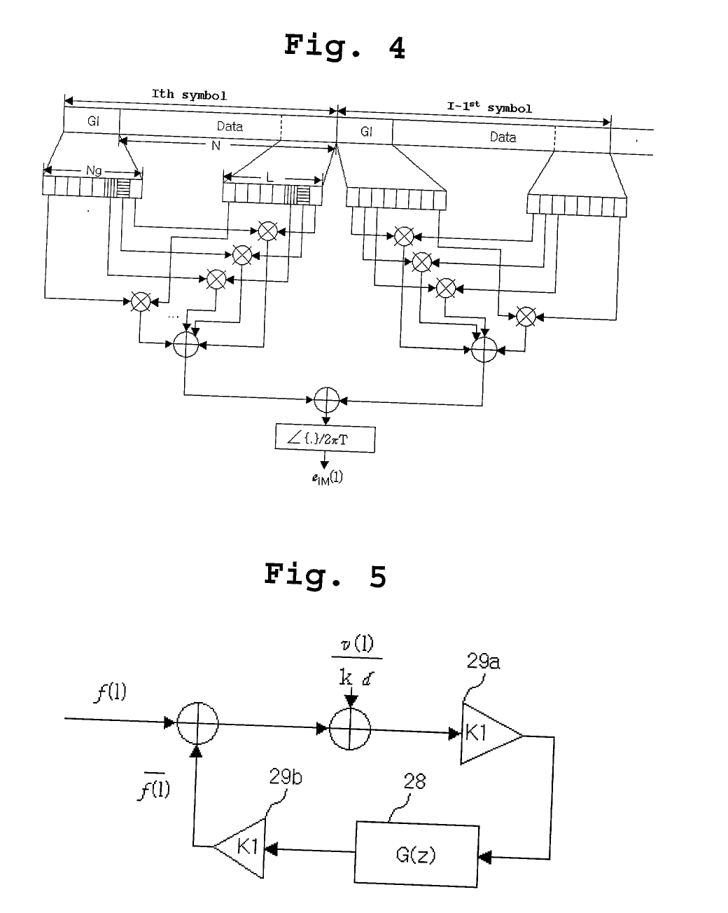

At this time, as shown in FIG. 4, the I-1^{st} symbol and the Ith symbol include N_{g} data GI of the protection period and N actual available data. In the method for receiving signals of the OFDM system according to the present invention, L data from the data of the protection period and the actual available data are respectively multiplied by each other and added to each other so that the error signals are generated in accordance with phase difference of the successive symbols.

Normalized formats of the error signals using a multi protection period based on the error detector of the present invention can be expressed by the following equations (3) and (4).

$$\begin{matrix}{e}_{1 M} ( l ) = \frac{1}{2 π T} ∠ \{ {\sum }_{m = 0}^{M - 1} {\sum }_{l = 1}^{L} ( {γ}_{I - m , N - l } \times {γ}_{I - m , - l}^{*} ) \} & ( 3 ) \\ {e}_{2 M} ( l ) = \frac{1}{N} {\sum }_{m = 0}^{M - 1} {\sum }_{l = 1}^{L} I m ( {γ}_{I - m , N - l} \times {γ}_{I - m , - l}^{*} ) & ( 4 )\end{matrix}$$

In the above equations, M represents the number of buffers used to store data of a protection period of a previous symbol, γ_{a,b} represents bth data among actual data of ath symbol, and γ*_{a,b} represents bth data among data of a protection period of the ath symbol.

If the number of the data for use in the OFDM system increases, frequency jitter increases by added noise. That is, the error signals according to the equation (4) are not converged but the error signals according to the equation (3) are removed by averaging the frequency jitter.

Therefore, in the receiver of the OFDM system according to the present invention, it is preferable that the error signals according to the equation (3) are used. Particularly, since trade-off exists between complexity of the system to be implemented and required performance, it is preferable that two buffers are used in the receiver of the OFDM system according to the present invention.

When two buffers are used, M=2 is obtained and the error signals of the error detector are obtained by the following equation (5).

$${e}_{1 M} ( l ) = \frac{1}{2 π T} ∠ \{ {\sum }_{l = 1}^{L} ( {γ}_{, N - l } \times {γ}_{, - l}^{*} + {γ}_{I - 1 , N - l} \times {γ}_{I - 1 , - l}^{*} ) \} \qquad ( 3 )$$

In the equation (5) referring to FIG. 4, γ_{I,N-2} represents horizontally striped data of the protection period of the Ith symbol, γ*_{I,-2} represents horizontally striped data of the protection period of the Ith symbol, γ_{I,N-3} represents vertically striped data of the protection period of the Ith symbol, and γ*_{I,-3} represents vertically striped data of the protection period of the Ith symbol.

In the OFDM system of the present invention according to the equation (5), error due to a random signal can be reduced using the data of the protection period and the actual data of the successive OFDM symbols. That is, it is possible to improve performance by considering phase difference of the two successive symbols.

The performance of the signal receiver of the OFDM system according to the present invention constructed and operated as above and the signal receiving method can be analyzed as follows.

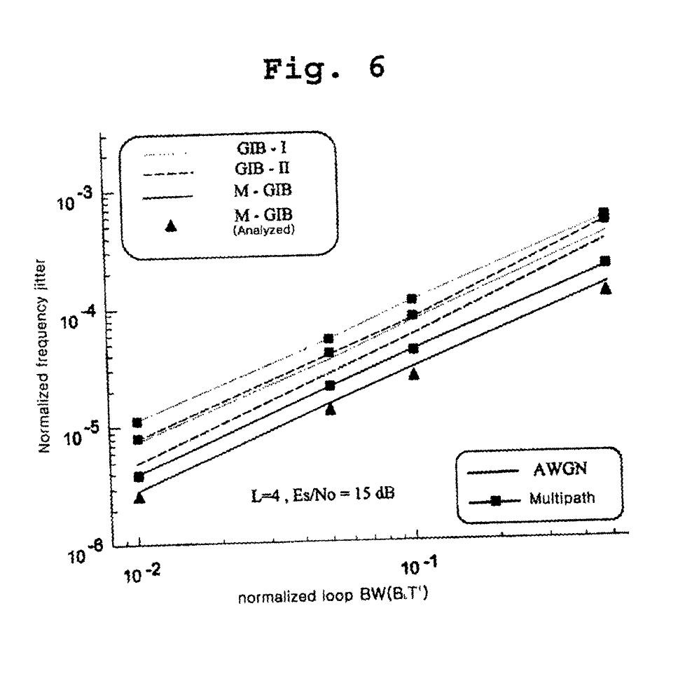

First, to analyze steady-state performance in AWGN channel, an equivalent digital model as shown in FIG. 4 is used. In FIG. 5, f(l) represents input frequency, \overline{f(l)} represents output frequency of the VCO, v(l) represents random zero-mean noise, k_{d} represents gain of the frequency error detector,

$$G ( z ) = \frac{{k}_{z} {z}^{- 1}}{1 - {z}^{- 1}}$$

represents a function block 28 of a digital loop filter, and K₁ represents gain of filters 29a and 29b. Steady-state frequency jitter σ²_{f} in the output of the VCO is obtained as follows using spectral analysis.

$${σ}_{Δ f}^{2} = T {\int }_{- 1 / 2 T}^{1 / 2 T2} \frac{{S}_{v} ( f )}{{k}_{d}^{2}} \vert H ( {ⅇ}^{j2π f T} ) {\vert}^{2} ⅆ f \qquad ( 6 )$$

In actual case, since Sᵥ (f) is almost flat in the range of ±B_{L} around the origin, Sᵥ (f) can be assumed as Sᵥ(0) and this is equal to dispersion of v(l). Steady-state noise normalized using the equation (5) can be expressed as follows.

$$v ( l ) = \overline{ϵ ( l )} - ϵ = \frac{1}{2 π} {tan}^{- 1} \{ \frac{I m \{ {\sum }_{l = 1}^{L} ( {γ}_{I , N - l } \times {γ}_{I , - l}^{*} + {γ}_{I - 1 , N - l} \times {γ}_{I - 1 , - l}^{*} ) {ⅇ}^{- j2πϵ} \}}{R e \{ {\sum }_{l = 1}^{L} ( {γ}_{I , N - l } \times {γ}_{I , - l}^{*} + {γ}_{I - 1 , N - l} \times {γ}_{I - 1 , - l}^{*} ) {ⅇ}^{- j2πϵ} \}} \} \qquad ( 7 )$$

In the above equation (7), \overline{ε(l)} and ε (l) respectively represent estimated frequency offset and actual offset normalized in the Ith OFDM symbol. |\overline{ε(l)}−(l)|≅0 is obtained and when L is sufficiently large, a tangent function can be approximated to argument. In high signal to noise ratio, the equation (7) is expressed as follows.

$$\vert \overline{ϵ ( l )} - ϵ ( l ) \vert ≅ \frac{1}{2 π} \{ \frac{I m \{ {\sum }_{l = 1}^{L} ( Δ ) \}}{{\sum }_{l = 1}^{L} ( \vert {S}_{I , N - l} {\vert}^{2} + \vert {S}_{I - 1 , N - l} {\vert}^{2}} \} \qquad ( 8 )$$

In the above equation (8), Δ=S_{I,N-l} W*_{I,-l}+S*_{I,N-l} W_{I,-l} e^{j-2πε}+S_{I-1,N-l} W*_{I-l,-l}+S*_{I-1,N-l} W_{I-1,-l} e^{-2πε},

$${S}_{I , n} = \frac{1}{\sqrt{N}} {\sum }_{k = 0}^{N - 1} {X}_{I , k} {ⅇ}^{j2π n k / N} ,$$

and w_{I,n} represents AWGN of nth sub channel in the Ith OFDM symbol. Finally, the following equation can be obtained using relation of

$${σ}_{s}^{2} = \frac{N - {N}_{v}}{N} {σ}_{x}^{2} .$$

$${σ}_{Δ f T}^{2} = \frac{1}{2 L} \frac{N}{N - {N}_{v}} \frac{1}{{( 2 π )}^{2}} \frac{1}{S N R} 2 {B}_{L} T . \qquad ( 9 )$$

In the equation (9) B_{L}=∫₀^{1/2T}|H(e^{j2πfT})|²df is defined by noise frequency width of the PLL and Nᵥ means the number of sub channels used to prevent aliasing.

The performance of the error detector of the signal receiver of the OFDM system according to the present invention is as follows.

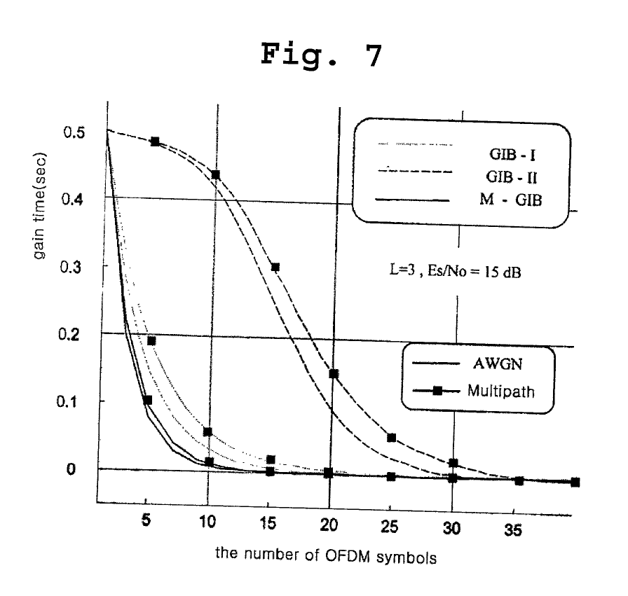

FIG. 6 is a graph of normalized frequency jitter to PLL noise frequency width B_{L}T when Eₛ/N₀=15 dB and L=4 in the steady-state. It is noted that σ²_{ΔfT} of M-GIB FED according to the present invention suggested in the AWGN channel is about 2.3˜2.5 times lower than the related art GIB FED-I and 1.7˜2.3 times lower than the related art GIB FED-II. It is also noted that σ²_{ΔfT} of the error detector in the multipath channel is about 1.3˜1.6 times higher than that of the AWGN channel.

In the multipath channel, the error detector has a value limited by floor effect in spite of increase of the length of L. This is because that noise by ISI also increases if the L increases. Accordingly, it is important to select a suitable length of L when the system is designed. To support 155 Mbps, the length of L that satisfies σ²_{ΔfT}=10⁻⁴ when Eₛ/N₀=15 dB and B_{L}T=0.1 is respectively 5, 3, and 2 to GIB FED-I, GIB FED-II, and M-GIB FED. When L=8, σ²_{ΔfT} of the M-GIB FED according to the present invention is about 2.1 times lower than GIB FED-I and 2.1 times lower than GIB FED-II.

FIG. 7 is a graph illustrating the result of an average gain time of the error detector when Eₛ/N₀=15 dB and L=3. A parameter value of the PLL that satisfies σ²_{ΔfT}=10⁻⁴ has been selected and initially normalized frequency offset has been assumed as ΔfT=0.5. As a result, it is noted that the M-GIB FED according to the present invention requires 10 symbols to maintain residual frequency offset ΔfT lower than 0.01. In the multipath channel, the M-GIB FED is converged about 0.18 times faster than the GIB FED-I and about 3.2 times faster than the GIB FED-II.

As described above, the signal receiver of the OFDM system and the method for receiving signals thereof according to the present invention have the following advantages.

After successive data are extracted/operated/stored from the receiving signals of the OFDM system for each unit of symbol, considering the phase difference of the successive symbols, error due to the random signal can be reduced and the error signals that remove the frequency offset of the receiving signals and synchronize the receiving signals are generated through the error detector of the PLL. When sufficient performance is not obtained due to the length of the data of the protection period used in the OFDM system or frequency efficiency required for the OFDM system is relatively high, the OFDM system having an improved performance can be provided.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A signal receiver of an OFDM system comprising:
a PLL for generating error signals using successive data among receiving signals of a symbol unit and synchronizing the receiving signals in accordance with the error signals;
an S/P converter for converting the synchronized signals to parallel signals;
a Fourier transform unit for fast Fourier transforming the converted parallel signals;
a signal modulation unit for modulating amplitude and phase of the Fourier transformed signals; and
a P/S converter for converting the modulated signals to serial signals.

2. The signal receiver of an OFDM system of claim 1, wherein the PLL includes:
a multiplexer for removing frequency offset of external receiving signals in accordance with the generated error signals;
an A/D converter for converting the signals, in which the frequency offset is removed through the multiplexer, to digital signals and outputting the converted digital signals to the S/P converter;
an error detector for adding the successive data of the receiving signals output through the A/D converter to generate the error signals in accordance with phase difference of the receiving signals;
a D/A converter for converting the error signals generated by the error detector to analog signals;
a loop filter for converting the analog signals converted through the D/A converter to direct current (DC);
a VCO for synchronizing the error signals in accordance with the DC converted through the loop filter to remove the frequency offset of the receiving signals in the multiplexer and at the same time synchronize the receiving signals.

3. The signal receiver of an OFDM system of claim 2, wherein the error detector includes at least one buffer that stores a first resultant value obtained by adding data of a protection period corresponding to an I-1^{St} symbol among the receiving signals output through the A/D converter to actual available data and at the same time stores a third resultant value obtained by adding the first resultant value to a second resultant value obtained by adding data of a protection period corresponding to an Ith symbol of the receiving signals to the actual available data.

4. A method for receiving signals of an OFDM system comprising the steps of:
a) generating error signals using successive data among receiving signals of the OFDM system for each unit of symbol;
b) removing frequency offset of the receiving signals in accordance with the generated error signals and synchronizing the receiving signals; and
c) modulating amplitude and phase of the synchronized receiving signals to process the modulated signals in the OFDM system.

5. The method of claim 4, wherein the step a) includes the steps of extracting signals of the protection period from the receiving signals and adding successive data of the protection period to the actual available data to generate the error signals.

6. The method of claim 5, the step a) includes the steps of:
respectively multiplying and adding L data of the protection period of the I-1^{st} symbol by and to L actual available data to store a first resultant value;
respectively multiplying and adding L data of the protection period of the Ith symbol by and to L actual available data to generate a second resultant value so that the second resultant value is added to the first resultant value; and
generating the error signals due to phase difference of two successive symbols in accordance with a third resultant value generated by adding the first resultant value to the second resultant value.

7. The method of claim 6, wherein the generated error signals are expressed by the following equation when ∠(•) is an angle of (•):
$${e}_{1 M} ( l ) = \frac{1}{2 π T} ∠ \{ {\sum }_{m = 0}^{M - 1} {\sum }_{l = 1}^{L} ( {γ}_{I - m , N - l} \times {γ}_{I - m , - l}^{*} ) \}$$
where, e_{1M} represents error signals generated in accordance with the L data, M represents the number of buffers used to store data of the protection period, N is the number of the actual available data, γ_{a,b} represents bth data among actual available data of ath symbol, and γ*_{a,b} represents bth data among data of a protection period of the ath symbol.

8. The method of claim 7, wherein the generated error signals are expressed by the following equation when two buffers are used to store data of the protection period in accordance with relation between complexity and performance of the OFDM system:
$${e}_{1 M} ( l ) = \frac{1}{2 π T} ∠ \{ {\sum }_{l = 1}^{L} ( {γ}_{, N - l} \times {γ}_{, - l}^{*} + {γ}_{I - 1 , N - l} \times {γ}_{I - 1 , - l}^{*} ) \}$$

9. The method of claim 7, wherein the generated error signals are expressed by the following equation when Im(•) is an imaginary value of (•)
$${e}_{2 M} ( l ) = \frac{1}{N} {\sum }_{m = 0}^{M - 1} {\sum }_{l = 1}^{L} I m ( {γ}_{I - m , N - l} \times {γ}_{I - m , - l}^{*} )$$
where, e_{2M}(l) represents error signals generated in accordance with the L data, M represent the number of buffers used to store data of the protection period, N is the number of the actual available data, γ*_{a,b} represents bth data among actual data of ath symbol, and γ*_{a,b} represents bth data among data of a protection period of the ath symbol.
